(19) United States
(12) Patent Application Publication
(10) Pub. No.: US 2019/0302795 A1
(43) Pub. Date: Oct. 3, 2019

(54) VEHICLE CONTROL DEVICE

(71) Applicant: HONDA MOTOR CO., LTD., Tokyo (JP)

(72) Inventors: Sachio KOBAYASHI, Wako-Shi (JP); Eiki SATO, Wako-Shi (JP)

(21) Appl. No.: 16/370,027

(22) Filed: Mar. 29, 2019

(30) Foreign Application Priority Data
Apr. 2, 2018 (JP) 2018-070784

(51) Int. Cl. G05D 1/02; B60W 30/095; B60W 30/165; G08G 1/00

(52) U.S. Cl. CPC G05D 1/0246; B60W 30/0956; B60W 10/04; G08G 1/22; B60W 30/165

(57) ABSTRACT

If a recognition unit fails to recognize a travel lane, a vehicle control unit estimates a first lane on the basis of the position of an object other than the travel lane that is recognized by the recognition unit, estimates a second lane on the basis of the travel lane that was recognized until the recognition unit has failed to recognize the travel lane, and performs vehicle control by using at least one of the first lane and the second lane in a case where a difference between the first lane and the second lane is within a predetermined range.

### CROSS-REFERENCE TO RELATED APPLICATION

This application is based upon and claims the benefit of priority from Japanese Patent Application No. 2018-070784 filed on Apr. 2, 2018, the contents of which are incorporated herein by reference.

### BACKGROUND OF THE INVENTION

### Field of the Invention

The present invention relates to a vehicle control device that performs vehicle control by recognizing an object (recognition object) that exists in a periphery of a host vehicle.

### Description of the Related Art

Japanese Laid-Open Patent Publication No. 2011-514580 (PCT) discloses a driver assistance system that causes a vehicle to travel along a lane. When the lane is recognized, this system detects a lane mark or, as an alternative to the lane mark, a restriction object that is built, such as a sidewalk curbstone.

### SUMMARY OF THE INVENTION

If the lane mark cannot be detected, the system according to Japanese Laid-Open Patent Publication No. 2011-514580 (PCT) can recognize the lane by detecting the sidewalk curbstone or the like. However, compared with the recognition accuracy of the lane on the basis of the lane mark, the recognition accuracy of the lane on the basis of the sidewalk curbstone or the like is low and the accuracy of vehicle control is also low.

The present invention has been made in view of the above problem and an object is to provide a vehicle control device that can perform vehicle control with high accuracy by recognizing a lane.

A vehicle control device according to the present invention includes: a detection unit configured to detect a periphery of a host vehicle that travels on a travel lane; a recognition unit configured to recognize an object that exists around the periphery of the host vehicle on a basis of a detection result from the detection unit; and a vehicle control unit configured to perform vehicle control of the host vehicle on a basis of a recognition result from the recognition unit, wherein if the recognition unit fails to recognize the travel lane, the vehicle control unit is configured to estimate a first lane on a basis of a position of the object other than the travel lane that is recognized by the recognition unit, estimate a second lane on a basis of the travel lane that was recognized until the recognition unit has failed to recognize the travel lane, and perform the vehicle control by using at least one of the first lane and the second lane in a case where a difference between the first lane and the second lane is within a predetermined range.

In the above configuration, when the travel lane is estimated, the two lanes (the first lane and the second lane) are estimated and it is determined whether the difference therebetween is within the predetermined range. Thus, the lane can be accurately estimated. Then, if the difference is within the predetermined range, it is determined that the reliability of the two lanes is high and the vehicle control is performed by using at least one lane. Therefore, the vehicle control can be performed with high accuracy.

In the present invention, the vehicle control unit may be configured to estimate the first lane on a basis of the position of the object that moves.

In the above configuration, the lane can be accurately estimated by using a movement trajectory of the object.

In the present invention, in the case where the difference between the first lane and the second lane is within the predetermined range, the vehicle control unit may be configured to estimate an intermediate lane between the first lane and the second lane, and perform the vehicle control by using the intermediate lane.

In the above configuration, the intermediate lane can be accurately estimated based on the two lanes (the first lane and the second lane) with high reliability, and the vehicle control is performed by using the intermediate lane. Therefore, the vehicle control can be performed with high accuracy.

In the present invention, the vehicle control unit may be configured to weight the first lane in accordance with the number of objects that is used when the first lane is estimated, and estimate the intermediate lane.

As the number of the objects used when the first lane is estimated is larger, the reliability of the first lane is higher. In the above configuration, as the number of the objects becomes larger, the intermediate lane becomes closer to the first lane. Thus, the lane can be accurately estimated.

In the present invention, in a case where the difference between the first lane and the second lane is out of the predetermined range, the vehicle control unit may be configured to stop at least a part of the vehicle control.

In the above configuration, if the difference is out of the predetermined range, it is determined that the reliability of the two lanes (the first lane and the second lane) is low and at least a part of the vehicle control is stopped. That is to say, the stop of the vehicle control can be appropriately determined.

In the present invention, the object that moves may be another vehicle that travels around the periphery of the host vehicle.

In the present invention, in the case where the difference between the first lane and the second lane is within the predetermined range, the vehicle control unit may be configured to perform the vehicle control by using the second lane, and in a case where the difference between the first lane and the second lane is out of the predetermined range, the vehicle control unit may be configured to perform the vehicle control by using the first lane.

In the above configuration, if the difference between the first lane and the second lane is within the predetermined range, the vehicle control is performed based on the second lane. That is to say, the vehicle control is performed based on positional information of the travel lane that is actually recognized by the recognition unit. Thus, in a case where the vehicle is controlled in a lateral direction (steering control) by recognizing the travel lane, the change in behavior of the host vehicle in the lateral direction can be suppressed before and after a recognition state of the travel lane is changed. Moreover, in the above configuration, if the difference between the first lane and the second lane is out of the predetermined range, the vehicle control is performed based on the first lane. That is to say, the vehicle control is performed based on positional information of the object recognized by the recognition unit that exists around the periphery of the host vehicle. Thus, the vehicle control can be performed without the contact with the object around the host vehicle.

By the present invention, the lane can be accurately estimated and the vehicle control can be performed with high accuracy.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a configuration diagram of a vehicle control device according to one embodiment;

FIG. 2 illustrates a host vehicle and an object that exists in a periphery of the host vehicle;

FIG. 3 is a flowchart of a process that is performed in the vehicle control device;

FIG. 4 is a diagram that is used for describing an estimation method for a first lane (first method);

FIG. 5 is a diagram that is used for describing the estimation method for the first lane (second method);

FIG. 6 is a diagram that is used for describing the estimation method for the first lane (third method);

FIG. 7 is a diagram that is used for describing an estimation method for a second lane;

FIG. 8 is a diagram that is used for describing a comparison method for the first lane and the second lane; and

FIG. 9 is a flowchart of a process that is performed in Modification 2.

### DESCRIPTION OF THE PREFERRED EMBODIMENTS

A preferred embodiment of a vehicle control device according to the present invention is hereinafter described in detail with reference to the attached drawings.

### 1. Configuration of Vehicle Control Device 10

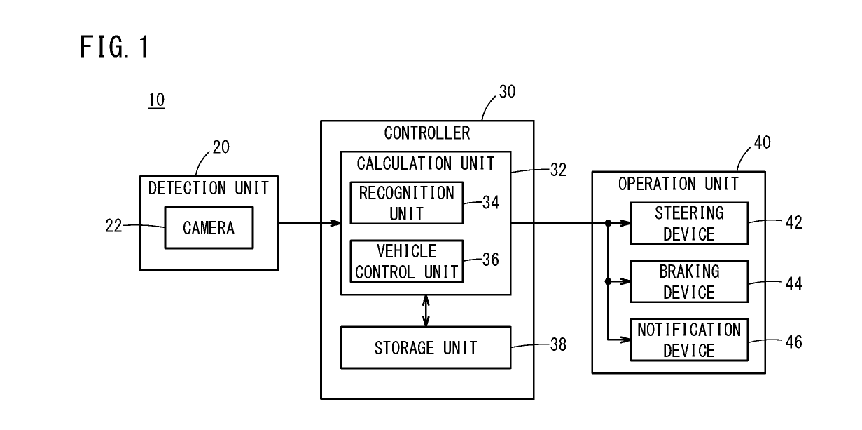

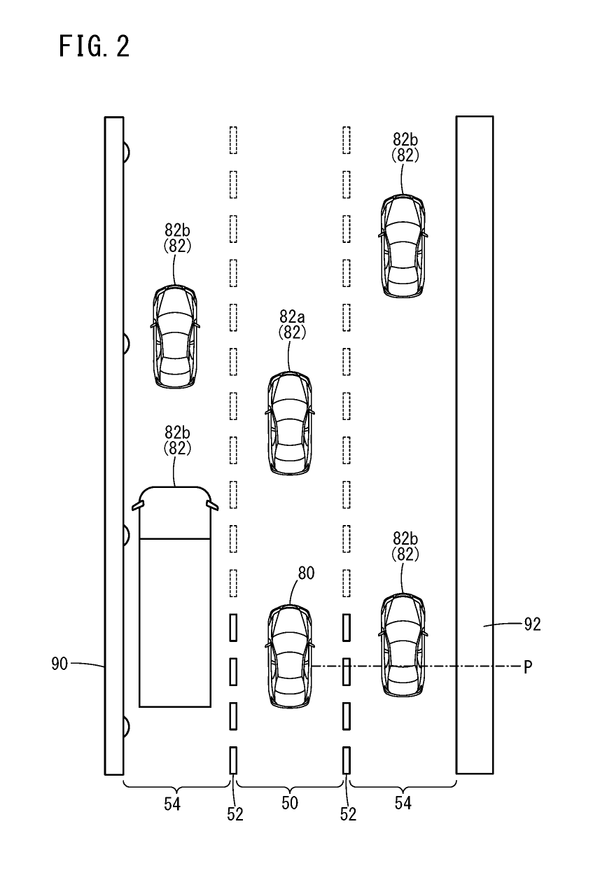

A configuration of a vehicle control device 10 according the present embodiment is described with reference to FIG. 1. The vehicle control device 10 is provided to a host vehicle 80 (FIG. 2, etc.) and performs vehicle control that includes steering control or steering assistance of the host vehicle 80. The vehicle control device 10 includes a detection unit 20, a controller 30, and an operation unit 40.

The detection unit 20 includes one or more devices that detect a periphery (external environment) of the host vehicle 80, for example, one or more cameras 22. The camera 22 is provided to the host vehicle 80 to capture images of at least an area ahead of the host vehicle 80. Instead of or in addition to the camera 22, a LIDAR may be used. A detection result from the detection unit 20, that is, image information acquired by the camera 22 (and/or detection information acquired by the LIDAR) is output to the controller 30.

The controller 30 is an electronic control unit (ECU) in which a calculation unit 32 and a storage unit 38 are integrated. The calculation unit 32 is a processor that includes a CPU and the like. The calculation unit 32 achieves various functions by executing programs stored in the storage unit 38. In the present embodiment, the calculation unit 32 functions as a recognition unit 34 and a vehicle control unit 36. The recognition unit 34 recognizes an object (recognition object) that exists in the periphery the host vehicle 80 on the basis of the detection result from the detection unit 20. For example, as illustrated in FIG. 2, the object includes, in addition to a moving object on a road, such as another vehicle 82 and a person (not shown), a road component such as lane marks 52, a travel lane 50 that is sectioned by the lane marks 52, different lanes 54 other than the travel lane 50, a guard rail 90, a curbstone (not shown), and a road shoulder 92. The vehicle control unit 36 performs the vehicle control (including travel assistance) of the host vehicle 80 on the basis of a recognition result from the recognition unit 34. The information from the detection unit 20 is input to the calculation unit 32, and the calculation unit 32 outputs the information to the operation unit 40. The storage unit 38 includes a ROM, a hard disk, or the like in addition to a RAM.

The operation unit 40 includes a steering device 42, a braking device 44, and a notification device 46. The steering device 42 includes an electric power steering system (EPS) ECU, and an EPS actuator. The steering device 42 generates a steering force in response to a vehicle occupant's operation on a steering wheel or a steering control instruction that is output from the controller 30. The braking device 44 includes a brake ECU and a brake actuator. The braking device 44 generates a braking force in response to a vehicle occupant's operation on a brake pedal or a braking control instruction that is output from the controller 30. The notification device 46 includes a notification ECU and an information transmission device (such as a display device, an audio device, or a haptic device). The haptic device includes parts with which the vehicle occupant is in contact, for example, the steering wheel, a seat, or a seat belt, and a device that operates (for example, vibrates) the parts. The notification device 46 notifies the vehicle occupant in response to a notification control instruction that is output from the controller 30 or another ECU.

### 2. Operation of Vehicle Control Device 10

As illustrated in FIG. 2, the vehicle control device 10 recognizes the travel lane 50 where the host vehicle 80 travels, and controls the host vehicle 80 in a lateral direction, that is, performs the steering control. The steering control herein described includes, in addition to automated steering that performs a steering operation instead of a driver, the steering assistance that assists a part of the steering operation performed by the driver. Specific examples of the steering control include lane keeping control that causes the host vehicle 80 to travel along a center line of the travel lane 50 and deviation prevention control that prevents the host vehicle 80 from deviating from the travel lane 50.

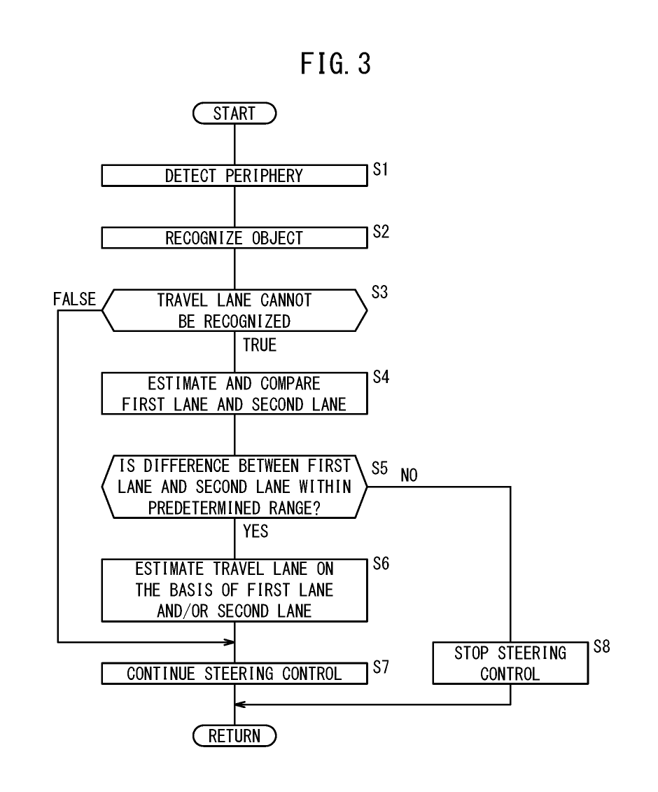

The steering control that is performed by the vehicle control device 10 according to the present embodiment is described with reference to FIG. 3. A process shown in FIG. 3 is performed at predetermined time intervals while the vehicle control device 10 performs the steering control. The process shown in FIG. 3 is performed on the basis of the circumstance illustrated in FIG. 2. The vehicle control device 10 recognizes the lane mark 52 on the basis of the image information acquired by the camera 22, and performs the steering control so that the host vehicle 80 travels along the travel lane 50. In FIG. 2, dashed lines express the lane marks 52 that are not recognized by the recognition unit 34.

In step S1, the detection unit 20, that is, the camera 22 in the present embodiment detects the periphery of the host vehicle 80, and outputs the acquired image information to the controller 30.

In step S2, the recognition unit 34 performs a process of recognizing the object (image recognition process) that exists around the periphery of the host vehicle 80 on the basis of the image information. Here, the recognition unit 34 recognizes the two lane marks 52 that exist on both sides of the host vehicle 80 in a width direction and extend in a traveling direction, and recognizes an area that is sectioned by the two lane marks 52 as the travel lane 50 where the host vehicle 80 travels. When the recognition unit 34 recognizes the lane mark 52, positional information of the lane mark 52 is stored in the storage unit 38. The storage unit 38 temporarily stores the positional information of the lane mark 52 for a predetermined travel time or a predetermined travel distance. On the other hand, if the lane mark 52 is faint, the recognition unit 34 cannot recognize the lane mark 52 and the travel lane 50 at a point P illustrated in FIG. 2, for example.

If the recognition unit 34 cannot recognize the travel lane 50 (step S3: TRUE), the process advances to step S4. On the other hand, the recognition unit 34 can recognize the travel lane 50 (step S3: FALSE), the process advances to step S7.

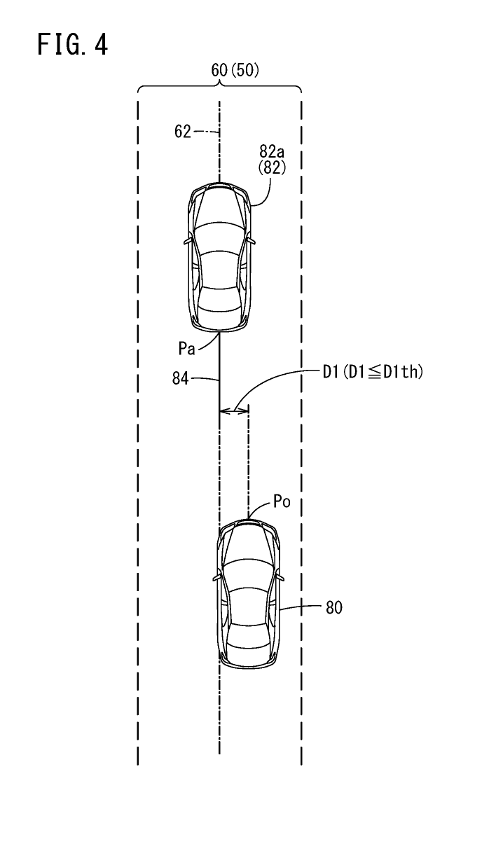

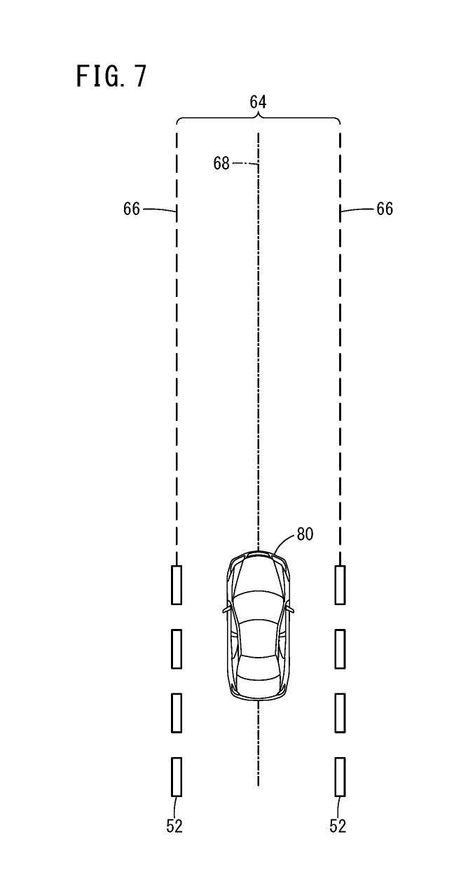

When the process has advanced from the step S3 to step S4, the vehicle control unit 36 estimates or calculates a first lane 60 (FIG. 4 to FIG. 6) on the basis of the position of the object other than the travel lane 50 that is recognized by the recognition unit 34. In addition, the vehicle control unit 36 estimates a second lane 64 (FIG. 7) on the basis of the travel lane 50 that was recognized until the recognition unit 34 has failed to recognize the travel lane 50. Then, the first lane 60 and the second lane 64 that are estimated are compared. An estimation method and a comparison method for the first lane 60 and the second lane 64 will be described in [3].

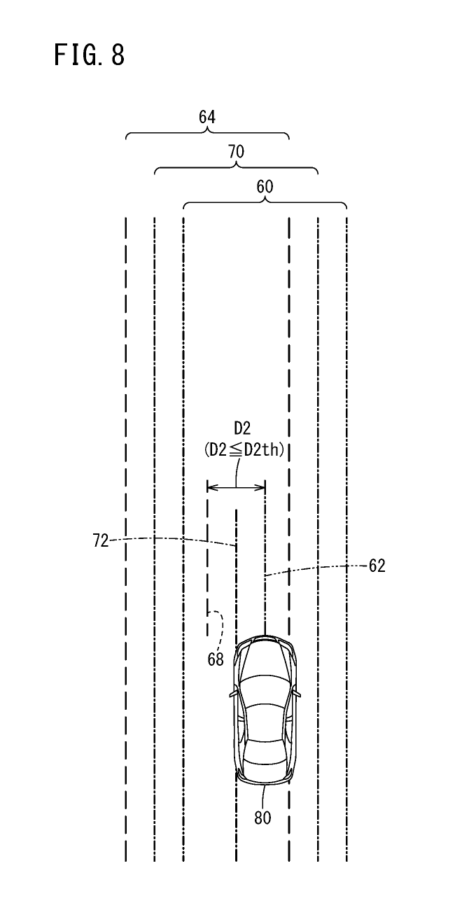

As a result of the comparison, if a difference D2 (FIG. 8) between the first lane 60 and the second lane 64 is within a predetermined range D2th (step S5: YES), the process advances to step S6. On the other hand, the difference D2 between the first lane 60 and the second lane 64 is out of the predetermined range D2th (step S5: NO), the process advances to step S8.

When the process has advanced from step S5 to step S6, the vehicle control unit 36 estimates the travel lane 50 on the basis of the first lane 60 and/or the second lane 64. If the difference D2 between the first lane 60 and the second lane 64 is within the predetermined range D2th, it means that the first lane 60 estimated based on current information (position of object) and the second lane 64 estimated based on past information (position of travel lane 50) are close to each other. In this case, the reliability of both the first lane 60 and the second lane 64 is high. Then, the vehicle control unit 36 presumes that the first lane 60 is the travel lane 50, for example. An estimation method for the travel lane 50 will be described in [4].

When the process has advanced from step S3 or step S6 to step S7, the vehicle control unit 36 continues the steering control. In a case where the lane keeping control is performed as the steering control, the vehicle control unit 36 calculates the steering amount required for causing the host vehicle 80 to travel along the center line of the travel lane 50 that is recognized in step S2 or the travel lane 50 that is estimated in step S6, and outputs the calculated steering amount to the steering device 42 as a steering instruction value. The steering device 42 performs steering in accordance with the steering instruction value. In a case where the deviation prevention control is performed as the steering control, the vehicle control unit 36 predicts whether the host vehicle 80 deviates from the travel lane 50. If the vehicle control unit 36 predicts the deviation, the vehicle control unit 36 outputs a notification instruction to the notification device 46. The notification device 46 performs notification in accordance with the notification instruction to warn the vehicle occupant. In addition, the vehicle control unit 36 calculates the steering amount required for causing the host vehicle 80 to return to the travel lane 50, and outputs the calculated steering amount to the steering device 42 as the steering instruction value. The steering device 42 performs the steering in accordance with the steering instruction value. If it is predicted that the deviation amount is large, the vehicle control unit 36 calculates the deceleration amount, and outputs the deceleration amount to the braking device 44 as a deceleration instruction value. The braking device 44 performs braking in accordance with the deceleration instruction value.

When the process has advanced from step S5 to step S8, the vehicle control unit 36 stops the steering control. If the difference D2 between the first lane 60 and the second lane 64 is out of the predetermined range D2th, it means that the first lane 60 estimated based on the current object information and the second lane 64 estimated based on the past lane information are not close to each other. In this case, the reliability of both the first lane 60 and the second lane 64 is low. Then, since the vehicle control unit 36 cannot acquire the information of the travel lane 50 with high reliability, the vehicle control unit 36 stops the steering control.

### 3. Estimation Method and Comparison Method for First Lane 60 and Second Lane 64

### [3.1. Estimation Method for First Lane 60]

The estimation of the first lane 60 in step S4 in FIG. 3 is described with reference to FIG. 4 to FIG. 6. The recognition unit 34 recognizes the objects that exist around the periphery of the host vehicle 80, and the position of each object. The vehicle control unit 36 estimates the position of the first lane 60 on the basis of positional information of one or more objects that are recognized by the recognition unit 34. The position of the first lane 60 is appropriately estimated based on information of the number, type, and position of the objects, for example. One example of the estimation method is hereinafter described.

### (1) First Method

A first method is described with reference to FIG. 4. The vehicle control unit 36 can estimate the position of the first lane 60 on the basis of positional information of the other vehicle 82 that is traveling. For example, the position of the first lane 60 can be estimated based on a travel trajectory 84 of a preceding vehicle 82a that is presumed to travel on the travel lane 50 where the host vehicle 80 travels. If a difference (positional displacement in width direction) D1 between a predetermined position of the host vehicle 80 in the width direction (for example, center position Po) and a predetermined position of the other vehicle 82 in the width direction (for example, center position Pa) is within a predetermined difference D1th, the vehicle control unit 36 presumes that the other vehicle 82 is the preceding vehicle 82a.

If there is the preceding vehicle 82a, the vehicle control unit 36 monitors a movement trajectory of the predetermined position of the preceding vehicle 82a recognized by the recognition unit 34 in the width direction, for example, the center position Pa, and determines that this movement trajectory is the travel trajectory 84 of the preceding vehicle 82a. Then, the vehicle control unit 36 estimates the first lane 60 that extends forward, in which the travel trajectory 84 is a first center line 62.

### (2) Second Method

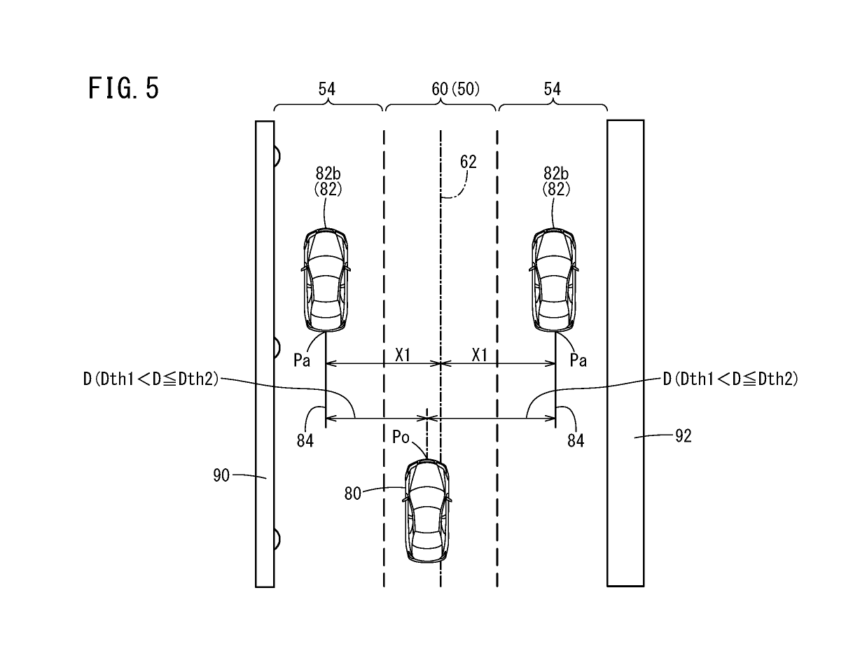

A second method is described with reference to FIG. 5. The vehicle control unit 36 can estimate the position of the first lane 60 on the basis of the positional information of the other vehicle 82 that is traveling. For example, the position of the first lane 60 can be estimated based on positional information of parallel travelling vehicles (or referred to as side travelling vehicles) 82b that are presumed to travel on the different lanes 54 that exist on both sides of the travel lane 50. If the difference (positional displacement in width direction) D1 between the predetermined position of the host vehicle 80 in the width direction (for example, center position Po) and the predetermined position of the other vehicle 82 in the width direction (for example, center position Pa) is more than a first predetermined difference D1th1 and less than or equal to a second predetermined difference D1th2, the vehicle control unit 36 presumes that the other vehicle 82 is the side travelling vehicle 82b.

If the side travelling vehicles 82b exist on both sides of the host vehicle 80, the vehicle control unit 36 monitors the movement trajectory of the predetermined position of each side travelling vehicle 82b recognized by the recognition unit 34 in the width direction, for example, the center position Pa, and determines that this movement trajectory is the travel trajectory 84 of the side travelling vehicle 82b. Then, the vehicle control unit 36 estimates the first center line 62 that extends forward at an intermediate position between the travel trajectory 84 of one side travelling vehicle 82b and the travel trajectory 84 of the other side travelling vehicle 82b, so as to estimate the first lane 60 that extends forward along the first center line 62.

If the side travelling vehicle 82b exists on only one side of the host vehicle 80, the vehicle control unit 36 estimates the first center line 62 that extends forward at a position away from the center position Pa of the side travelling vehicle 82b to the host vehicle 80 side in the width direction by a predetermined distance X1, so as to estimate the first lane 60 that extends forward along the first center line 62.

### (3) Third Method

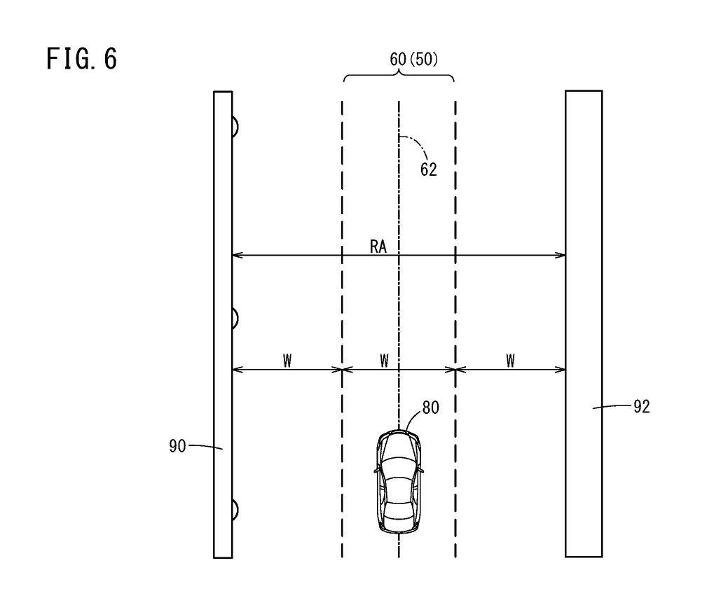

A third method is described with reference to FIG. 6. The vehicle control unit 36 can estimate the position of the first lane 60 on the basis of positional information of the road component. For example, the position of the first lane 60 can be estimated based on positional information of the guard rail 90 or the road shoulder 92 existing along the travel lane 50. The recognition unit 34 recognizes information of the number of lanes in a travel path, the position of the travel lane 50 (what number the travel lane 50 is from the end), each lane width W, and the like while recognizing the travel lane 50. Each piece of information that is recognized at this time is stored in the storage unit 38.

When the vehicle control unit 36 has failed to recognize the travel lane 50, the vehicle control unit 36 estimates the position of each lane by dividing a road area RA between the guard rail 90 and the road shoulder 92 into the number of the lanes that is stored in the storage unit 38. Then, the vehicle control unit 36 presumes that the position of the lane where the host vehicle 80 travels is the position of the first lane 60 and the center thereof is the first center line 62 of the first lane 60.

Alternatively, the vehicle control unit 36 estimates the lane for each lane width W that is stored in the storage unit 38 from the position of the guard rail 90 or the road shoulder 92 to the width direction. Then, the vehicle control unit 36 presumes that the lane corresponding to the position of the travel lane 50 stored in the storage unit 38 is the first lane 60 and the center thereof is the first center line 62 of the first lane 60.

### (4) Fourth Method

It can be presumed that an intermediate position of the first center lines 62 estimated by using two or more methods (for example, first method to third method as described above) is the final first center line 62 of the first lane 60.

For example, the vehicle control unit 36 can presume that an intermediate position between the first center line 62 of the first lane 60 that is estimated based on the moving object (for example, the other vehicle 82) and the first center line 62 of the first lane 60 that is estimated based on a stationary object (for example, guard rail 90 and road shoulder 92) is the final first center line 62 of the first lane 60. In this case, it may be possible to weight the first center line 62 of the first lane 60 that is estimated based on the moving object, in accordance with the number of the moving objects. If it is assumed that the position of the first center line 62 of the first lane 60 that is estimated based on the moving object is Y, the position of the first center line 62 of the first lane 60 that is estimated based on the stationary object is Z, and the number of the moving objects is n, then the position of the final first center line 62 is expressed by {(n/n+1)Y+(1/n+1)Z}/2. In this case, as the number n becomes larger, the position of the final first center line 62 becomes closer to the position of the first center line 62 of the first lane 60 that is estimated based on the moving object.

### [3.2. Estimation Method for Second Lane 64]

The estimation of the second lane 64 in step S4 in FIG. 3 is described with reference to FIG. 7. The vehicle control unit 36 can estimate the position of the second lane 64 on the basis of the positional information of the lane mark 52 that is stored in the storage unit 38 in step S2 in FIG. 3. If the lane mark 52 that is stored in the storage unit 38 is a straight line, the vehicle control unit 36 estimates a virtual lane mark 66 that overlaps with an extension line of the lane mark 52 and that has a straight line shape. In addition, if the lane mark 52 that is stored in the storage unit 38 is a curved line, the vehicle control unit 36 estimates the virtual lane mark 66 that overlaps the extension line of the lane mark 52 and that has a curved line shape. Then, the vehicle control unit 36 presumes that the lane that is sectioned by the virtual lane mark 66 is the second lane 64 and the center thereof is a second center line 68 of the second lane 64.

### [3.3. Comparison Method for First Lane 60 and Second Lane 64]

The comparison of the first lane 60 and the second lane 64 in step S4 in FIG. 3 is described with reference to FIG. 8. The vehicle control unit 36 compares the first lane 60 and the second lane 64 by comparing the position of the first center line 62 and the position of the second center line 68. At this time, the vehicle control unit 36 determines the difference (positional displacement in width direction) D2 between the first center line 62 and the second center line 68.

### 4. Estimation Method for Travel Lane 50

The estimation of the travel lane 50 in step S6 in FIG. 3 is described.

### (1) First Method

In step S4 in FIG. 3, the vehicle control unit 36 estimates the first lane 60 (FIG. 3 to FIG. 6) and the second lane 64 (FIG. 7). As described above, the vehicle control unit 36 may presume that the first lane 60 is the travel lane 50, or that the second lane 64 is the travel lane 50.

### (2) Second Method

As illustrated in FIG. 8, the vehicle control unit 36 may estimate an intermediate lane 70 existing at an intermediate position between the first lane 60 and the second lane 64, and presume that the intermediate lane 70 is the travel lane 50. In this case, the vehicle control unit 36 estimates an intermediate center line 72 existing at an intermediate position between the first center line 62 and the second center line 68. Then, the vehicle control unit 36 estimates the intermediate lane 70 by using the intermediate center line 72 as a center. If it is assumed that the position of the first center line 62 is A and the position of the second center line 68 is B, the position of the intermediate center line 72 is expressed by (A+B)/2.

### (3) Third Method

The second method can be changed as described below. The vehicle control unit 36 may weight the first lane 60 in accordance with the number of the objects that is used when the first lane 60 is estimated, and set the position of the intermediate lane 70. If it is assumed that the position of the first center line 62 is A, the position of the second center line 68 is B, and the number of the objects that is used when the first center line 62 is estimated is n, then the position of the intermediate center line 72 is expressed by {(n/n+1)A+(1/n+1)B}/2. In this case, as the number n becomes larger, the position of the intermediate lane 70 becomes closer to the position of the first lane 60.

### 5. Modifications

### (1) Modification 1

The present embodiment can be modified variously. For example, in the process in FIG. 3, if the difference D2 between the first lane 60 and the second lane 64 is out of the predetermined range D2th (step S5: NO), the vehicle control unit 36 stops the steering control (step S8). Alternatively, the vehicle control unit 36 may pull over the host vehicle 80. In this case, the vehicle control unit 36 outputs a control instruction in order to pull over the host vehicle 80 to the steering device 42, and outputs the control instruction in order to stop the host vehicle 80 to the braking device 44.

### (2) Modification 2

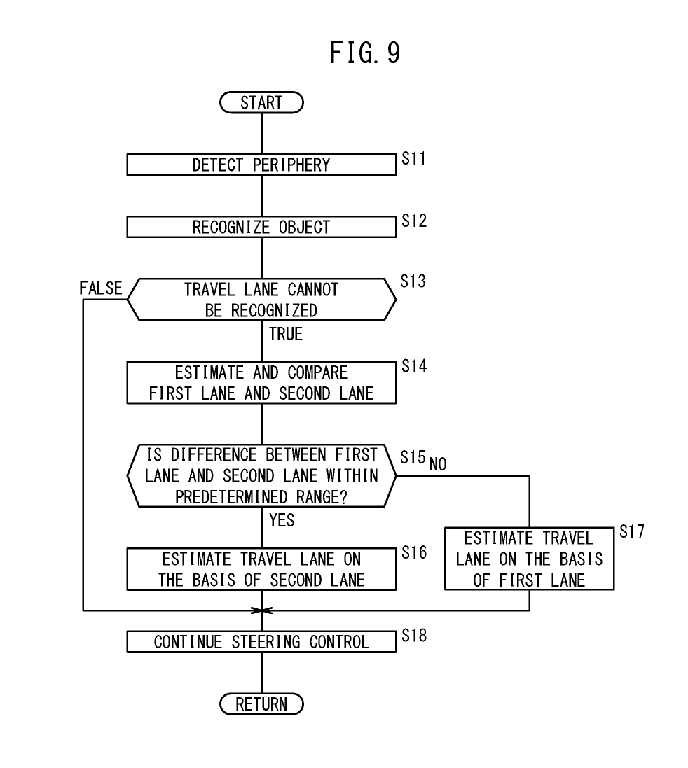

One of the first lane 60 and the second lane 64 may be selected as the travel lane 50 in accordance with the difference D2 between the first lane 60 and the second lane 64. In Modification 2, the process is performed in accordance with a flowchart in FIG. 9. The process in step S11 to step S15 and step S18 in FIG. 9 is the same as the process in step S1 to step S5 and step S7 in FIG. 3.

When the process has advanced from step S15 to step S16, the vehicle control unit 36 estimates the travel lane 50 on the basis of the second lane 64. Specifically, the vehicle control unit 36 presumes that the second lane 64 is the travel lane 50. On the other hand, when the process has advanced from step S15 to step S17, the vehicle control unit 36 estimates the travel lane 50 on the basis of the first lane 60. Specifically, the vehicle control unit 36 presumes that the first lane 60 is the travel lane 50.

### (3) Modification 3

When the first lane 60 is estimated, the vehicle control unit 36 may refer to the position of the person who moves or stops outside the guard rail 90.

### 6. Summary of the Present Embodiment and Modifications

The vehicle control device 10 includes: the detection unit 20 configured to detect the periphery of the host vehicle 80 that travels on the travel lane 50; the recognition unit 34 configured to recognize the object that exists around the periphery of the host vehicle 80 on the basis of the detection result from the detection unit 20; and the vehicle control unit 36 configured to perform the vehicle control of the host vehicle 80 on the basis of the recognition result from the recognition unit 34. If the recognition unit 34 fails to recognize the travel lane 50, the vehicle control unit 36 is configured to estimate the first lane 60 on the basis of the position of the object other than the travel lane 50 that is recognized by the recognition unit 34, estimate the second lane 64 on the basis of the travel lane 50 that was recognized until the recognition unit 34 has failed to recognize the travel lane 50, and perform the vehicle control by using at least one of the first lane 60 and the second lane 64 in the case where the difference D2 between the first lane 60 and the second lane 64 is within the predetermined range D2th.

In the above configuration, when the travel lane 50 is estimated, the two lanes (the first lane 60 and the second lane 64) are estimated and it is determined whether the difference D2 therebetween is within the predetermined range D2th. Thus, the lane can be accurately estimated. Then, if the difference D2 is within the predetermined range D2th, it is determined that the reliability of the two lanes is high and the vehicle control is performed by using at least one lane. Therefore, the vehicle control can be performed with high accuracy.

The vehicle control unit 36 is configured to estimate the first lane 60 on the basis of the position of the object that moves, for example, the position of the other vehicle 82.

In the above configuration, the lane can be accurately estimated by using the movement trajectory of the object, for example, the travel trajectory 84 of the other vehicle 82.

In the case where the difference D2 between the first lane 60 and the second lane 64 is within the predetermined range D2th, the vehicle control unit 36 is configured to estimate the intermediate lane 70 between the first lane 60 and the second lane 64, and perform the vehicle control by using the intermediate lane 70.

In the above configuration, the intermediate lane 70 can be accurately estimated based on the two lanes (the first lane 60 and the second lane 64) with high reliability, and the vehicle control is performed by using the intermediate lane 70. Therefore, the vehicle control can be performed with high accuracy.

The vehicle control unit 36 is configured to weight the first lane 60 in accordance with the number n of objects that is used when the first lane 60 is estimated, and estimate the intermediate lane 70.

As the number n of the objects used when the first lane 60 is estimated is larger, the reliability of the first lane 60 is higher. In the above configuration, as the number n of the objects becomes larger, the intermediate lane 70 becomes closer to the first lane 60. Thus, the lane can be accurately estimated.

In the case where the difference D2 between the first lane 60 and the second lane 64 is out of the predetermined range D2th, the vehicle control unit 36 is configured to stop at least a part of the vehicle control.

In the above configuration, if the difference D2 is out of the predetermined range D2th, it is determined that the reliability of the two lanes (the first lane 60 and the second lane 64) is low and at least a part of the vehicle control is stopped. That is to say, the stop of the vehicle control can be appropriately determined.

In the case where the difference D2 between the first lane 60 and the second lane 64 is within the predetermined range D2th, the vehicle control unit 36 is configured to perform the vehicle control by using the second lane 64, and in the case where the difference D2 between the first lane 60 and the second lane 64 is out of the predetermined range D2th, the vehicle control unit 36 is configured to perform the vehicle control by using the first lane 60.

In the above configuration, if the difference D2 between the first lane 60 and the second lane 64 is within the predetermined range D2th, the vehicle control is performed based on the second lane 64. That is to say, the vehicle control is performed based on the positional information of the travel lane 50 that is actually recognized by the recognition unit 34. Thus, in the case where the vehicle is controlled in the lateral direction (steering control) by recognizing the travel lane 50, the change in behavior of the host vehicle 80 in the lateral direction can be suppressed before and after the recognition state of the travel lane 50 is changed. Moreover, in the above configuration, if the difference D2 between the first lane 60 and the second lane 64 is out of the predetermined range D2th, the vehicle control is performed based on the first lane 60. That is to say, the vehicle control is performed based on the positional information of the object recognized by the recognition unit 34 that exists around the periphery of the host vehicle 80. Thus, the vehicle control can be performed without the contact with the object around the host vehicle 80.

The vehicle control device according to the present invention is not limited to the embodiment above, and can employ various configurations without departing from the gist of the present invention.

What is claimed is:

1. A vehicle control device comprising:
a detection unit configured to detect a periphery of a host vehicle that travels on a travel lane;
a recognition unit configured to recognize an object that exists around the periphery of the host vehicle on a basis of a detection result from the detection unit; and
a vehicle control unit configured to perform vehicle control of the host vehicle on a basis of a recognition result from the recognition unit,
wherein if the recognition unit fails to recognize the travel lane, the vehicle control unit is configured to estimate a first lane on a basis of a position of the object other than the travel lane that is recognized by the recognition unit, estimate a second lane on a basis of the travel lane that was recognized until the recognition unit has failed to recognize the travel lane, and perform the vehicle control by using at least one of the first lane and the second lane in a case where a difference between the first lane and the second lane is within a predetermined range.

2. The vehicle control device according to claim 1, wherein the vehicle control unit is configured to estimate the first lane on a basis of the position of the object that moves.

3. The vehicle control device according to claim 1, wherein in the case where the difference between the first lane and the second lane is within the predetermined range, the vehicle control unit is configured to estimate an intermediate lane between the first lane and the second lane, and perform the vehicle control by using the intermediate lane.

4. The vehicle control device according to claim 3, wherein the vehicle control unit is configured to weight the first lane in accordance with number of objects that is used when the first lane is estimated, and estimate the intermediate lane.

5. The vehicle control device according to claim 1, wherein in a case where the difference between the first lane and the second lane is out of the predetermined range, the vehicle control unit is configured to stop at least a part of the vehicle control.

6. The vehicle control device according to claim 2, wherein the object that moves is another vehicle that travels around the periphery of the host vehicle.

7. The vehicle control device according to claim 1, wherein in the case where the difference between the first lane and the second lane is within the predetermined range, the vehicle control unit is configured to perform the vehicle control by using the second lane, and in a case where the difference between the first lane and the second lane is out of the predetermined range, the vehicle control unit is configured to perform the vehicle control by using the first lane.
